(19) United States
(12) Patent Application Publication
(10) Pub. No.: US 2006/0155600 A1
(43) Pub. Date: Jul. 13, 2006

(54) Method of mass marketing for quick service food restaurants through print advertising upon sanitizing wipes packaging

(76) Inventor: Steven Glenn Mays, Pleasant Hill, CA (US)

Correspondence Address: Steven G. Mays, 225 Coggins Dr. # 246, Pleasant Hill, CA, 94523, US

(21) Appl. No.: 11/236,164

(22) Filed: Sep. 26, 2005

Related U.S. Application Data
(60) Provisional application No. 60/612,839, filed on Sep. 24, 2004.

(51) Int. Cl. G07G 1/14

(52) U.S. Cl. 705/14

(57) ABSTRACT

A business method of mass marketing consisting of providing the customers' of quick service food restaurants, who order their food to go, either from a drive-thru, or in a restaurant, a means of sanitizing their hands prior to touching their food. While solving the need of their customers to eat with clean hands, the method also provides the restaurant a way to market themselves by virtue of the goodwill they will build in providing a hand sanitizing means to their customers and also through the re-emphasizing of the provision of this service to their customers, by print advertising upon one or more faces of the sanitizing implement and/or its packaging.

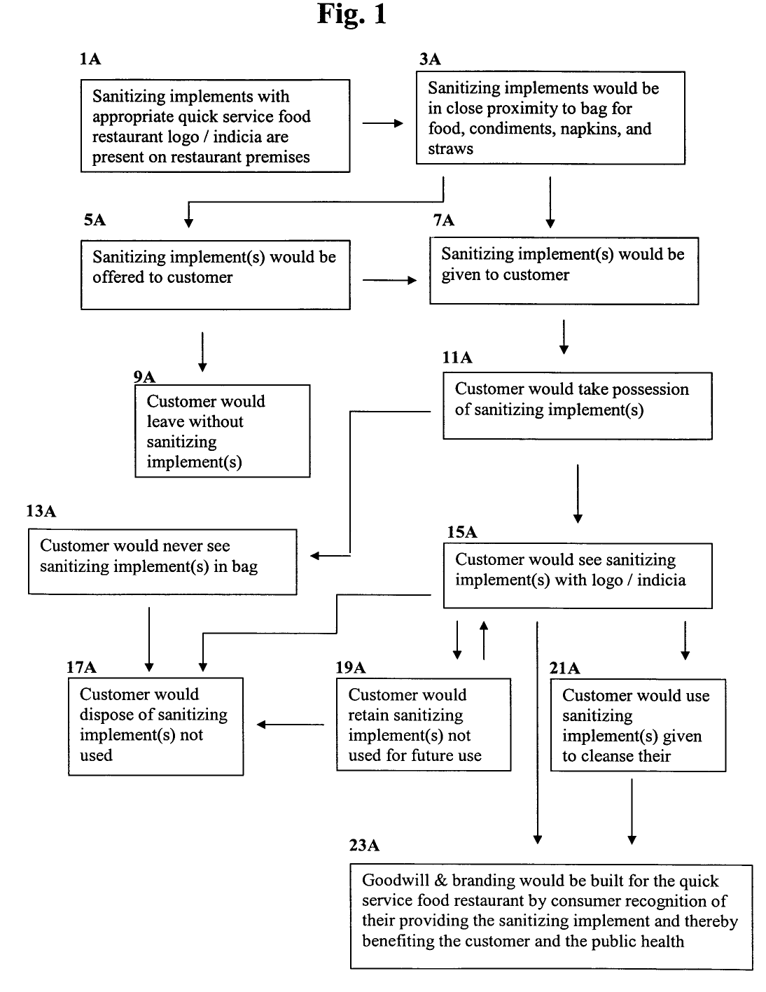

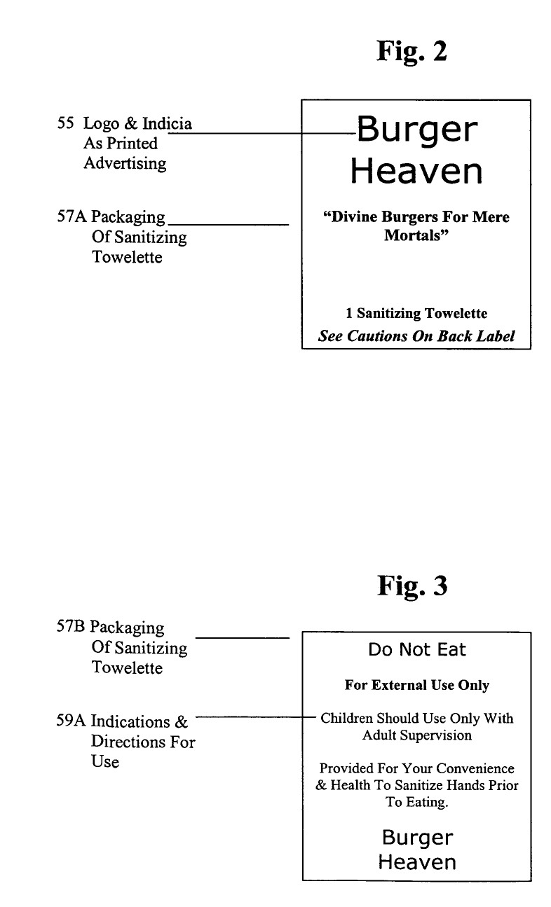

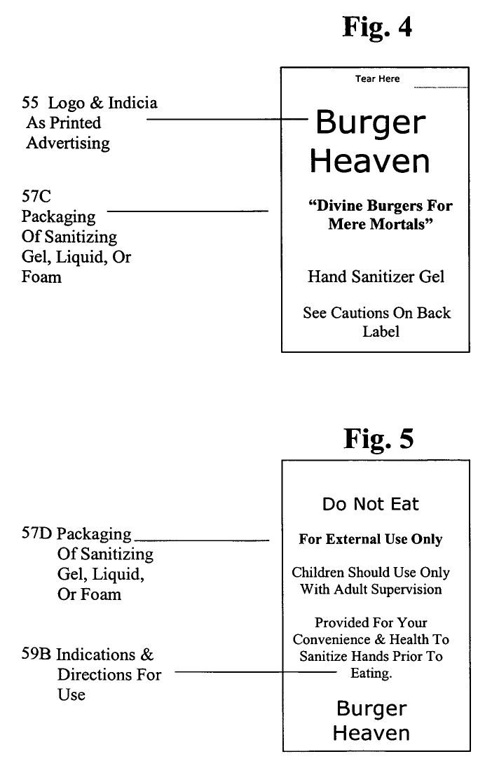

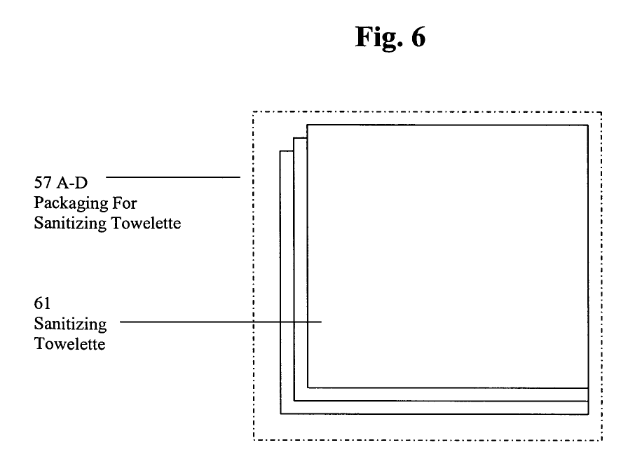

### BACKGROUND OF THE INVENTION

1. Field of Invention

The invention is a business method, specifically, a method of mass marketing through the dissemination of a useful item with print advertising or indicia on one or more faces of the item.

2. Prior Art

Restaurants, such as those serving whole pieces of chicken, ribs, or other meats or foods whereby a customer is likely to touch such foods with their hands, often provide a towel, wash cloth, towlette or wipe to assist the customer in cleaning their hands of grease or other food residues after they have finished eating. Some of these establishments have print advertising on the package of after meal wipes or towlettes used to clean the hands after touching greasy foods. No patent was ever issued for any business method associated with providing patrons of restaurants a means to remove food residues from their hands with the use of wipes or towlettes with or without printed logos, indicia, or other advertising upon them. Such towelettes and wipes fall within the public domain.

Some establishments such as casinos provide a towlette or wipe for patrons to clean their hands after touching frequently touched items such as slot machines.

Anti-bacterial and other types of sanitizing wipes, foams, gels, liquids and the like are sold at stores for the purpose of enabling people to clean their hands. These usually have advertising upon faces of their packaging to identify and promote the wipe itself as a product of the manufacturer or distributor or to promote the manufacturer or distributor as such for other lines of personal care products.

Numerous patents exist for the methods of manufacture, composition, and the structure of the non-woven materials used to manufacture towlettes as well as the finished towelettes themselves. Patents also exist for the packaging thereof, though none of these patents relate to any method of mass marketing for the quick service food industry by virtue of benefiting the public health and associating such benefit with the dispensing restaurant.

Numerous patents also exist for the methods of manufacture, and chemical structure and dosage of such chemicals used upon sanitizing towlettes or in creams, gels, or liquids which give sanitizing properties to such sanitizing products. Patents also exist for the packaging of such chemicals, with and without a wipe or towelette, though none of these patents relate to any method of mass marketing for the quick service food industry by virtue of benefiting the public health and associating such benefit with the dispensing restaurant.

Neither patents for non-woven materials, towelettes, the chemicals used upon them, the process of manufacture for any of these items, or the packaging of such items relates to a business method of mass marketing for quick service food restaurants.

U.S. Pat. No. 6,691,897, Ashe, et. al., was found to have significant relevance. U.S. Pat. No. 6,691,897 discloses a dispenser for antibacterial wipes, providing antibacterial wipes to the public, free of charge at sporting events and in other public places. This disclosed dispenser has advertising upon its faces. This patent clearly both benefits the public health by providing users of the wipes the ability to sanitize their hands, and benefits the advertiser by providing recognition and goodwill to their company. The patent discloses a mutually advantageous structure which provides benefit to all parties because the print advertising on the dispenser is covering the costs of the wipes being provided to the public.

While U.S. Pat. No. 6,691,897 has the ability to benefit the public health as well as the advertiser, particularly at large events and/or in public places, this patent fails to provide benefit to the millions of customers who purchase food through from quick service restaurants. Additionally, it is not conceivable how U.S. Pat. No. 6,691,897 could benefit customers who purchase food through from quick service restaurants who order their food through a drive-thru because of the risk of the dispenser described within the claims of the patents likelihood to interfere with the flow of traffic through the typically narrow drive-thru lanes.

3. Objects and Advantages

Accordingly, several objects and advantages of the invention are as follows;

The invention gives the millions of daily patrons of quick service food restaurants a means to sanitize their hands prior to touching their food. This is particularly desirable because it is well known that eating with clean hands is a means of preventing the introduction of pathogens into the body. Additionally, many customers ordering their food to go will have handled money immediately prior to receiving their food. Customers of quick service food restaurants who obtain their food through the drive through can be expected to have no means of sanitizing their hands prior to eating. Even customers who order food in the restaurant can be impeded from sanitizing their hands with the quick service restaurants facilities due to limited facilities and the fact that many restaurants only have hand driers and no paper towels available. This causes to have to touch the handle of the restroom door to leave the restroom without having a paper towel to use as a barrier between their skin and the door handle, likely contaminating their hands with bacteria commonly found on bathroom handles or door knobs.

Also, weather ordering in the restaurant or through the drive-thru many patrons may not have had the means or the presence of mind to sanitize their hands prior to arriving at the restaurant. Even if they were able to do so, touching their keys, surfaces within their car or other means of transportation, and the touching money needed to purchase food, would give the cause to sanitize their hands immediately prior to consuming their food.

While some patrons of quick service food restaurants do take their food to a locations where facilities are available for them to sanitizing their hands prior to the consumption of their food, a vast number of people do eat in their car once they have obtained their food.

Other objects and advantages of the invention are that in providing a means of hand sanitization to customers, quick service food restaurants are doing their customers a service. They are giving them the means to do something that many people want to do; clean their hand prior to eating. In providing this service to their customers the restaurants build goodwill with their customers.

Also in providing a sanitizing implement to customers, restaurants utilizing this invention put their logo or other indicia or advertising in front of their customer. This increases name recognition for the quick service restaurant and further associates the restaurant with the service they are providing to their customers.

Even one person sanitizing their hands prior to eating could benefit the public health. Collectively, more than 30 million people order their food to go at quick service food restaurants. On this scale the invention clearly provides a benefit to the public health.

### DETAILED DESCRIPTION

Prior to the scope of the business method invention disclosed herein, sanitizing (antibacterial) towelettes (often referred to as “wipes”) or sanitizing foam, liquid, or gel (57A-D, 61) is manufactured, packaged in packaging with the desired quick service food restaurants desired logo, indicia, or other advertising upon such packaging deemed appropriate by the quick service food restaurant.

The business method begins with the sanitizing towelette, gel, foam, or liquid (57A-D, 61), (hereafter referred to as “Sanitizing Implement”) being present upon the premises of the quick service food restaurant (1A).

The sanitizing implement (57A-D, 61) would be stored for disbursement to customers in a place within close proximity to other items (3A) given to the customers of quick service food restaurants who are ordering their food to go.

Once a customer places an order at the quick service food restaurant utilizing the business method, the customer would either be asked if they would like one or more sanitizing implements (57A-D, 61), or one or more sanitizing implements would be placed with the customers food or otherwise conveyed to the customer without the customer having to ask.

If the quick service food restaurant customer, ordering their food to go, indicated that they wished to receive one or more sanitizing implements (57A-D, 61) in response to being asked (5A), or if such implements (57A-D, 61) were simply given to the customer (7A), they would at this time be in possession of one or more sanitizing implements (57A-D, 61).

Having taken possession of one or more of the sanitizing (57A-D, 61) implements (7A), it might be the case, if for example the implements (57A-D, 61) were placed in a container along with the customers food, that the would neither see (13A), nor use the sanitizing implements (57A-D, 61). In this case, the sanitizing implements (57A-D, 61) would end up being disposed of (17A) along with the remains of the meal or the meals packaging as well as any other unused items.

If however, upon taking possession of the sanitizing (57A-D, 61) implements (7A), the customer did see them (15A), the customer would see the packaging of the sanitizing implement (57A-D, 61) with the quick service food restaurants logo, indicia, or other advertising (55) upon the packaging. At this point the customer may still choose not to use the sanitizing implement (57A-D, 61), and in such case the sanitizing implement (57A-D, 61) may still be discarded (17A).

It is also possible, and likely, based upon the utility of the sanitizing implement(s) (57A-D, 61), that upon seeing the sanitizing (57A-D, 61) implement (15A), that the customer of the quick service food restaurant would choose to use the sanitizing implement (57A-D, 61) for its intended purpose of sanitizing their hands (21A). Were this the case, goodwill (23A) may be established by the quick service food restaurant for helping the customer to accomplish something that many people are desirous of doing (cleaning their hands prior to eating) (21A) and reinforcing that it was the quick service food restaurant who provided them this service by virtue of their logo, indicia, or other advertising (55) upon the packaging of the sanitizing implement (57A-D, 61), also contributing to brand recognition (23A).

A final component of the business method invented is the possibility that some quick service food restaurant customers will not use some or all of the sanitizing implements (57A-D, 61) at the time they are provided to the customer by the quick service food restaurant. It is likely based on current consumer behavior (saving taco sauce, individual packaged condiments, and napkins from quick service food restaurants), that unused sanitizing implements (57A-D, 61) will be retained (19A) by a portion of customers. When this occurs, upon transferring the item to a place of storage and/or upon final use of the sanitizing implement (57A-D, 61), the customer of the quick service food restaurant will again see (15A) the sanitizing (57A-D, 61) implement with its accompanying logo, indicia, or other advertising further, contributing to branding and goodwill (15A) on the part of the quick service food restaurant for providing this useful item.

### PREFERRED EMBODIMENT

For the customers' of fast food restaurants who either obtain their food from the drive through window, or otherwise order food to go, a sanitizing, antibacterial, or otherwise cleansing wipe, foam, or liquid (hereafter referred to as sanitizing implements) would be provided by fast food restaurants to their customers so that they can clean their hands prior to eating. The sanitizing implements provided to such customers would have print and or graphical advertising on them, their packaging, or the dispenser from which they are obtained, thus contributing to branding and the building of goodwill towards the quick service food restaurant providing the wipes.

Since millions of people obtain fast food to go on a daily basis, the wipe with advertising as described would constitute a method of mass marketing/advertising not currently or previously engaged in while also benefiting the public health.

I have two preferred embodiments. The first would be an antibacterial or sanitizing wipe in a package with advertising on one or more faces of the package. The package would be made of paper, foil, plastic, cellophane, or other material or combinations of material with similar pliable properties. The packaging might have one or more areas of indentation, perforation, or other means to facilitate opening the package easily.

The second preferred embodiment, also a very common method of dispensing sanitizing implements, would he to use a gel, foam, or liquid sanitizer. The packaging for this embodiment could also be made from paper, foil, plastic, cellophane, or other material or combinations of material with similar pliable properties. The packaging might have one or more areas of indentation, perforation, or other means to facilitate opening the package easily.

### ALTERNATIVE EMBODIMENTS

The same business method could be accomplished in other embodiments than that of the preferred embodiment discussed above. Other cleansing implements could be used to accomplish the same purpose or step in this business method. A wipe could be folded, wadded or otherwise inserted into any type of packing included those already discussed or could be put into a box, a carton, a bag, or other means for containing and or preserving and or distributing it. A wipe could be used which contains one or more each of wet and dry portions on the same wipe. A dry wipe containing a bubble or other enclosure for a wet or other cleansing agent could be used. The wipe or cleansing implement could be supplied to the customer from a dispenser with print or graphical advertising on the dispenser itself. Too, the wipe could come in a plain package with no advertising upon it or from a dispenser lacking any advertising but have print or graphical advertising upon the wipe itself. Other means could be devised to accomplish the same method of marketing and advertising such as providing an antibacterial or other cleansing liquid, foam, agent or solution with advertising on some or all of the faces of some or all of the packaging, which would allow the customer to apply the antibacterial or other cleansing liquid, foam, agent or other solution for the purpose of cleaning their hands with or without a dry or wet wipe or other paper, cloth or like material in a same, different or attached package, for the purpose of removing any excess of the antibacterial or cleansing solution applied or otherwise dry their hands.

The same effectiveness of the business method could be achieved whether the anti-bacterial, sanitizing, or cleansing wipes or other similar implement was placed in the bag or other container in which the food was given to the customer, attached inside or outside of the food container, handed separately or with other items to the customer but not in a primary container such as a bag or box provided for the purpose of holding the food, or made available for the customer to themselves obtain. Any of these steps could be used to accomplish the same portion of the method, and would occur in close proximity to the time that a customer orders, receives or pays for their food. While not a method of print or graphical advertising, simply including a plainly packaged wipe or one with a manufacturer or distributor name, logo or the like other than that of the restaurant, would also fall into the same process of being useful to the customer and building goodwill, though would not yield the benefit of mass advertising were the restaurants' logo not somewhere on the cleansing wipe, or other similar implement, or its packaging.

### CONCLUSION

For fast food restaurants to solve the problem of much of their customer base having no immediate means to currently clean or otherwise sanitize their hands after touching money to pay for the food they are about to consume, and in so doing to be able to put their logo and or other promotional print or graphical materials or advertising into the hands of their customers, the disclosed business method provides a clear means of mass marketing/advertising. The method, in broad scope, results in a problem being solved for restaurant customers and by virtue of such, with the addition of logo, print, or graphical advertising, the restaurant is solving its own problem of how to accomplish the universal marketing objective of building goodwill by solving a problem or meeting a need for their customers, while increasing their visibility as a company. This method does all of the things.

1. A method of mass marketing is claimed by quick service food restaurants' disseminating sanitizing implements to their patrons for the purpose of patrons being able to sanitize their hands prior to eating, and in doing so, provide additional brand name exposure and general goodwill to the restaurant.

2. Printed matter upon the packaging of sanitizing or cleansing implements or dispensers for cleansing implants, is claimed as a means of advertising for quick service food restaurants.

3. The dissemination of sanitizing or cleansing to customers of quick service restaurants is claimed as a means of benefiting such customers and the public health.
